(19) United States
(12) Patent Application Publication
(10) Pub. No.: US 2020/0131344 A1
(43) Pub. Date: Apr. 30, 2020

(54) Epoxidized Natural Rubber Composition

(71) Applicant: Birla Carbon U.S.A., Inc., Marietta, GA (US)

(72) Inventors: Charles R HERD, Woodstock, GA (US); John C CURTIS, Kennesaw, GA (US); Zachary A. COMBS, Smyrna, GA (US); Andrew V CHAPMAN, Hertford (GB); Stuart COOK, Bassingbourn (GB); Paul S BROWN, Baldock (GB); Graham T SPILLER, Stevenage, Hertfordshire (GB); Jaymini PATEL, Harrow (GB)

(21) Appl. No.: 16/629,053

(22) PCT Filed: Jul. 9, 2018
(86) PCT No.: PCT/US2018/041227

§ 371 Date: Jan. 7, 2020

Related U.S. Application Data
(60) Provisional application No. 62/529,722, filed on Jul. 7, 2017.

(51) Int. Cl. C08L 7/00; B60C 1/00; B60C 11/00; C08J 3/22

(52) U.S. Cl. CPC C08L 7/00; B60C 1/0016; B60C 11/0008; C08J 3/226; C08L 2201/08; C08J 2307/00; C08J 2407/00; C08L 2205/025; B60C 2011/0025

(57) ABSTRACT

Epoxidized natural rubber compositions, elastomer blends containing an epoxidized natural rubber, and materials containing carbon black and epoxidized natural rubber.

### BACKGROUND

### Technical Field

The present invention relates to compositions comprising a functionalized elastomer and functionalized carbon black material, and specifically to compositions comprising an epoxidized natural rubber elastomer and a functionalized carbon black.

### Technical Background

In filled elastomer systems, such as, for example, compounds containing carbon black for use in manufacturing tires, it can be desirable to increase the level of interaction between the filler or carbon black and the elastomer and to reduce and/or eliminate filler-filler interactions. Undesirable filler-filler interactions can lead to filler networking, giving rise to heat generation during processing and use, and can result in compound hysteresis and high rolling resistance.

The reduction of rolling resistance in tire tread compounds is thus important in meeting future requirements for increased fuel economy of vehicles and reduced green house gas emission, such as carbon dioxide emissions. It is well known that one of the most significant contributions to heat buildup in elastomeric compounds and tire compounds that might normally be composed of styrene butadiene copolymers and butadiene or natural rubber polymer blends and carbon black, is the filler itself, as a result of filler networking. Thus it would be desirable and beneficial to reduce filler-filler networking and increase filler-elastomer interaction. Measurement of the degree of filler-filler networking is normally achieved through low strain dynamic mechanical testing of elastomeric compounds, where the low-strain, dynamic elastic modulus can be augmented or increased due to filler-filler networking. If the filler-filler networking is reduced in some manner, a corresponding reduction in the low-strain, dynamic elastic modulus will be observed. This phenomenon is termed the Payne Effect.

Thus, there is a need to address the aforementioned problems and other shortcomings associated with traditional and non-traditional filled elastomer systems. These needs and other needs are satisfied by the compositions and methods of the present invention.

### SUMMARY

In accordance with the purpose(s) of the invention, as embodied and broadly described herein, this disclosure, in one aspect, relates to carbon-black filled elastomeric materials, together with methods for the manufacture and use thereof.

In one aspect, the present disclosure provides an elastomer composition comprising a functionalized elastomer and a surface-functionalized carbon black.

In another aspect, the present disclosure provides a method for preparing an elastomer composition having reduced hysteresis, the method comprising contacting a functionalized elastomer and a surface-functionalized carbon black.

In another aspect, the present disclosure provides a method for contacting Epoxidized Natural Rubber (ENR) with a functionalized carbon black or silica for improved dispersion and compounding flexibility.

In yet another aspect, the present invention provides a method for contacting the surface-modified carbon black and normal carbon black in ENR with other elastomers to control the carbon black phase distribution (between elastomers) for optimized compound properties.

In yet another aspect, the present invention provides a method for contacting silica and surface-modified carbon black and/or unmodified carbon black, such as in ENR with other elastomers to control the phase distribution of fillers (e.g., silica and/or carbon black) between elastomers for optimized compound properties.

Any accompanying figures, which are incorporated in and constitute a part of this specification, illustrate several aspects and together with the description serve to explain the principles of the invention.

### BRIEF DESCRIPTION OF THE FIGURES

The accompanying figures, which are incorporated in and constitute a part of this specification, illustrate several aspects and together with the description serve to explain the principles of the invention. Each of the figures is described in the text.

FIG. 1 illustrates a change in dispersion with varied Epoxidized Natural Rubber/Natural Rubber content blends, in accordance with various aspects of the present disclosure.

FIG. 2 illustrates a change in modulus for Carbon Black Example B and N234 in NR and ENR compounds and blends, in accordance with various aspects of the present disclosure.

FIG. 3 illustrates a change in 300% modulus for Carbon Black Example B and N234 in NR and ENR compounds and blends, in accordance with various aspects of the present disclosure.

FIG. 4 illustrates a change in heat buildup for Carbon Black Example B and N234 in NR and ENR compounds and blends, in accordance with various aspects of the present disclosure.

FIG. 5 illustrates a change in Abrasion Resistance Rating for Carbon Black Example B and N234 in NR and ENR compounds and blends, in accordance with various aspects of the present disclosure.

FIG. 6 illustrates a change in Die C Tear Strength for Carbon Black Example B and N234 in NR and ENR compounds and blends, in accordance with various aspects of the present disclosure.

FIG. 7 illustrates atomic force microscopy (AFM) images of Carbon Black Example B in various NR/ENR blends, in accordance with various aspects of the present disclosure.

FIG. 8 depicts AFM images of N234/Carbon Black Example B blends of varied ratios in 50/50 NR/ENR.

FIG. 9 illustrates filler dispersion as a function of filler type and blend ratio, and elastomer blend ratio, in accordance with various aspects of the present disclosure.

FIG. 10 illustrates compound resistivity as a function of filler type and blend ration, and elastomer blend ratio, in accordance with various aspects of the present disclosure.

FIG. 11 illustrates the tangent delta max at 60° C., as a function of filler type and blend ratio, and elastomer blend ratio, in accordance with various aspects of the present disclosure.

FIG. 12 illustrates the Die C tear strength, as a function of filler type and blend ratio, and elastomer ratio, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Test methods are intended to refer to those commonly used in the carbon black industry and known to those of skill in the art thereof. In some cases, such tests represent ASTM tests and/or compositions prepared according to ASTM test methods. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the rubber industry to describe the relative amount of each ingredient in a composition.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As noted above, rubber compounds, especially for tires, frequently require low hysteresis and heat buildup for the production of low rolling resistance tires to meet increasing fuel economy standards and government labelling protocols. In one aspect, a low rolling resistance tire compound can be achieved through increased interaction between the carbon black and the elastomer, and/or reduced filler-filler interaction or networking.

Conventional methods that can be used to reduce filler-filler interaction and increase filler microdispersion in elastomeric compounds can include implementation of one or more of the following: broad distribution carbon blacks to increase the average inter-aggregate spacing and reduce filler-filler networking, (U.S. Pat. No. 7,238,741); coupling agents with carbon black (U.S. Pat. No. 5,494,955) or silica (U.S. Pat. No. 5,227,425) where the coupling agent increases the filler-elastomer interaction; combining silica and/or surface modified fillers with functionalized elastomers, such as chain-end functionalized SBR elastomers (U.S. Pat. No. 5,248,722 and US Patent Publication 2006/0178467) or epoxidized natural rubber (N.Y. Wan, K. P. Chin, and C. S. Mt. Saad, 9^{th} National Symposium on Polymeric Materials (NSPM 2009), IQP Conference Series Materials Science and Engineering, 11 (2010) 012004). Each of the patents, patent publications, and articles described above are incorporated herein for the purpose of disclosing components and interactions.

The above conventional approaches can yield favorable results in reducing hysteresis, but still maintain disadvantages. In various aspects, any of the compositions and methods described herein can be prepared or performed together with or in the absence of any of the above recited means to increase filler-elastomer interaction or reduce filler-filler interaction.

Broad distribution carbon blacks can provide limited reductions in compound hysteresis, providing reductions of only 5 to 10%, considering the use of tangent delta at 60° C. to 70° C. as a predictor of rolling resistance.

Silica compounds typically require the addition of extra ingredients, such as coupling agents (for increased filler-elastomer interaction) and dispersion aids. Silica compounds also typically need longer mixing and dispersion times, resulting in higher compound costs and lower throughput. Some of the additional ingredients needed for silica compounds, such as, for example, the common coupling agent, bis[3-triethoxysilyl)propyl] tetrasulfide (TESPT), can yield ethanol emissions during reactive mixing cycles. Silica can also be an abrasive filler and can cause premature degradation of mixing and processing equipment.

In addition to silica compounds, coupling agents can be used in combination with carbon blacks, but their impact on carbon black-elastomer interactions is typically low, providing little benefit in reducing hysteresis.

In one exemplary aspect, a surface-modified carbon black with an increased amount of oxygen-based functional groups can be combined with or without a normal non-functionalized carbon black, and a functionalized elastomer, such as, for example, an epoxidized natural rubber and/or blends of an epoxidized natural rubber with natural rubber, styrene butadiene rubber, and/or butadiene rubber. In one aspect, such compounds can provide tread and non-tread compounds that exhibit significantly reduced hysteresis or heat buildup, as compared to conventional tire formulations.

In other aspects, such compounds can provide hysteresis levels unattainable with typical carbon black-elastomer compounds. In other aspects, the resulting hysteresis levels from such compounds can approach or equal that of silica based compounds, without the adverse effects typical of such silica based compounds.

In one aspect, the compositions and methods of the present invention can reduce and/or eliminate the need for silica and coupling agents, which can add unnecessary cost and do not function well in natural rubber compounds. Silica-based compounds can also require higher temperature mixing (i.e., more energy intensive), and can result in high Mooney viscosity and poor processing. Additionally mixing of silica in natural rubber (NR) based compounds can result in elastomer breakdown and poor viscoelastic properties due to the requirement for higher temperature mixing. In other aspects, the present invention can provide performance similar to or comparable to that of silica based compounds, without the disadvantages of silica compounds. In still other aspects, silica can be present and can be mixed with the other components described herein.

In one aspect, the present disclosure provides an elastomer composition based on surface-treated carbon blacks and a functionalized polymer that does not require the use of expensive coupling agents. In another aspect, the inventive elastomer compositions and methods described herein do not result in premature wear of equipment, such as, for example, rubber mixers. In yet another aspect, the inventive elastomer compositions and methods described herein can provide significant reductions in compound hysteresis and can maintain traction performance and abrasion resistance at reasonable levels, in contrast to conventional carbon black or silica compositions that improve one two of these properties, yet typically leave a third property unchanged or even diminished in performance. In yet another aspect, the inventive elastomer compositions and methods can provide good dispersions and shorter mixing cycles, lower energy costs and higher factory throughput versus silica-based compound compositions.

In various aspects, the present invention relates to a compound composition and mixing sequence for preparation of the compound composition that utilizes surface-treated carbon blacks and functionalized elastomers. In particular the functionalized elastomer can be functionalized along the polymer chain and/or at the chain ends, and thus when combined with the surface modified carbon black, can increase the carbon black-elastomer interaction, reduce the subsequent carbon black network, and provide for a unique compound with substantially lower heat buildup and rolling resistance. Such compounds can require unique mixing procedures or additional surface treatment of the carbon black to allow proper mixing and filler dispersion to achieve the desired compound properties. Such compounds may be used in numerous rubber articles, but in particular they may be used in the manufacture of tires.

As briefly described above, the present disclosure provides elastomer compositions comprising a functionalized elastomer and a functionalized carbon black. In one aspect, the inventive compositions can provide improved filler-elastomer interactions and/or reduced filler-filler interactions. During processing and use, undesirable filler-filler interactions can generate heat and can result in hysteresis in the resulting compound. While not wishing to be bound by theory, a reduction in such filler-filler interactions can be exhibited as a decrease in the low strain dynamic modulus of the compound, resulting in a smaller change in the difference between the low strain and high strain dynamic modulus. It should be understood that the term composition, as used herein, can, in some instances, refer to a mixture of components, for example, elastomer and carbon black, prior to compounding and/or curing, while in other aspects, can refer to a compounded and/or cured mixture of the same. One of skill in the art would readily understand the intended meaning of each reference in the context of the description.

### Carbon Black

The carbon black of the present disclosure can comprise any carbon black material suitable for use in a filled elastomer composition. In one aspect, the carbon black can comprise a furnace carbon black. In another aspect, the carbon black can comprise an ASTM grade carbon black. In still another aspect, the carbon black can comprise a functionalized version of an ASTM grade carbon black. In yet another aspect, the carbon black can comprise a tread grade carbon black, such as, for example, an N110, N115, N121, N134, N220, N231, N234, N299, N330, N339, N343, N347, or N375 grade carbon black, or comprise a carcass grade carbon black, such as, for example, an N550, N539, N650, N660, N762, N772, N990. In other aspects, the carbon black can comprise a BC2045, BC 2056, CD2125XZ, or BC2109 grade carbon black, available from Birla Carbon, Marietta, Ga., USA. In other aspects, the carbon black can comprise any other carbon black or combination of carbon blacks suitable for use in a filled elastomer system.

In one aspect, the carbon black is a surface functionalized and/or surface treated carbon black having a plurality of surface functional groups capable of interacting with a functional group of the elastomer. In another aspect, the carbon black has a plurality of surface functional groups capable of interacting with the epoxide groups of an epoxidized natural rubber. In yet another aspect, the carbon black comprises an oxidized carbon black, prepared, for example, by treatment with acid, hydrogen peroxide, and/or ozonation. In yet another aspect, the carbon black comprises an amine treated carbon black that exhibits one or more functional groups capable of interacting with an epoxide group of an epoxidized natural rubber.

In one aspect, the surface treatment for a carbon black can comprise a surface treatment resulting in from about 1 to about 15% volatiles, for example, about 1, 2, 3, 4, 5, 6, 7, 8, 9, 10, 11, 12, 13, 14, or 15% volatiles. In another aspect, the surface treatment of the carbon black can comprise a surface treatment resulting in from about 2 to 8% volatiles, for example, about 2, 2.5, 3, 3.5, 4, 4.5, 5, 5.5, 6, 6.5, 7, 7.5, or 8% volatiles. In still another aspect, the surface treatment of the carbon black can comprise a surface treatment resulting in from about 4 to 6% volatiles, for example, about 4, 4.2, 4.4, 4.6, 4.8, 5, 5.2, 5.4, 5.6, 5.8, or 6% volatiles, as might be imparted upon ozonation, acid treatment, or peroxide treatment, and used as is or upon subsequent treatment with bases or alcohols.

In still other aspects, the carbon black can comprise an oxidized carbon black that is subsequently treated with a base, for example, an organic or inorganic base. In one aspect, the carbon black comprises oxygen containing, basic, or a combination of oxygen containing and basic functional groups.

In one aspect, the carbon black of the present disclosure can comprise a functionalized carbon black, for example, available from Birla Carbon, Marietta, Ga., USA. In another aspect, the carbon black of the present invention can comprise an unmodified carbon black, such as, for example, an N234 grade carbon black. In another aspect, the carbon black can comprise a mixture of a functionalized carbon black and an unmodified carbon black. In such an aspect, the carbon black can comprise a mixture of, for example, Carbon Black Example B and N234 grade carbon black. When a combination of individual carbon blacks are utilized, the proportions of each individual carbon black can vary, depending upon the specific properties of the individual carbon blacks and the desired properties of the resulting compound. In one aspect, the carbon black can comprise a 50/50 blend (based on weight) of N234 and Carbon Black Example B. In another aspect, the carbon black can comprise a 25/75 blend (based on weight) of N234 and Carbon Black Example B. In other aspects, the carbon black can comprise Carbon Black Example B, wherein a portion of the Carbon Black Example B is substituted with an unmodified carbon black, such as, N234. In such aspects, the substituted portion can comprise about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, or about 60 wt. % of the Carbon Black Example B. In another aspect, the substituted portion can comprise about 15 wt. %, about 20 wt. %, about 25 wt. %, about 30 wt. %, about 35 wt. %, or about 40 wt. % of the Carbon Black Example B. In still another aspect, the substituted portion can comprise about 20 wt. %, about 25 wt. %, or about 30 wt. % of the Carbon Black Example B. In various aspects, the carbon black of the present invention can comprise one or more of the carbon blacks listed below in Table 1. In another aspect, the carbon black of the present invention can comprise one or more other carbon blacks not specifically listed in Table 1 or in this application.

TABLE 1
Physical Properties of Carbon Blacks

| | | Carbon Black | Carbon Black | Carbon Black | | |
|---|---|---|---|---|---|---|
| | Method | Example A | Example B | Example C | N234 | N220 |
| Void Volume @ | ASTM D6086 | 55.6 | 55.6 | 55.6 | 60.3 | 56.1 |
| 75 MPa | | | | | | |
| EMSA m²/g | LS5-301 | lll | 123 | 123 | 120 | 117 |
| HEAT LOSS, % | ASTM D1509 | 2.9 | 4.3 | 3.3 | 0.4 | 0.2 |
| VOLATILES, % | LS2-700 | 3.1 | 5.5 | 6 | 1.5 | 1.3 |
| pH | ASTM D1512 | <3 | <3 | <3 | 7 | 7 |

In one aspect, variations of the functionalized carbon black can be used in lieu of, or together with, all or a portion of the functionalized carbon black. For example, all or a portion of the functionalized carbon black, such as, for example, Carbon Black Example B, can be replaced with a higher or lower structure version of the same. In one aspect, a carbon black, such as, for example, Carbon Black Example B, can comprise a CD2125XZ grade carbon black, available from Birla Carbon. In other aspects, variations of carbon black grades having lower or higher surface area can be used. As used herein and in the carbon black industry, the term structure is intended to refer to the size of a carbon black aggregate, as typically measured by oil absorption methods. In one aspect, a carbon black can have a nitrogen surface area of about 116 m²/g, an external surface area of about 101 m²/g, a heat loss of about 3.5 wt %, a volatile level of about 5.5 wt. %, and/or a void volume of about 55.6.

In still other aspects, the inventive composition can further comprise one or more chemicals to facilitate the interaction of the carbon black and the elastomer. In still another aspect, such chemicals can be reactively mixed with the elastomer compound.

### Elastomer

The elastomer of the present disclosure can comprise one or more individual elastomers, wherein at least one of the elastomers comprises an epoxidized natural rubber (ENR). In one aspect, an epoxidized natural rubber can be derived from the at least partial epoxidation of a natural rubber. In yet another aspect, an epoxidized natural rubber can have a plurality of epoxide groups distributed along the length of the natural rubber polymer.

In another aspect, as the epoxide groups can be located along the natural rubber's polymer chain, each polar epoxide group can potentially serve as a filler-elastomer interaction site. In contrast, traditional elastomers having only chain-end functional groups can only provide such interactions at the ends of the polymer chain.

In one aspect, the elastomer can comprise an epoxidized natural rubber, such as, for example, EKOPRENA™ 25 and/or EKOPRENA™ 50, with 25 to 50 mole % epoxidation, as manufactured and sold by: Malaysian Rubber Board, Rubber Research Institute Research Station, 47000, Sungai Buloh, Selangor, Malaysia. In other aspects, the elastomer can be a natural rubber (NR) with less than about 25 mole % epoxidation, for example, about 5 mole %, about 7 mole %, about 9 mole %, about 11 mole %, about 13 mole %, about 15 mole %, about 17 mole %, about 19 mole %, about 21 mole %, about 23 mole %, or about 24 mole %. It should be appreciated that the examples and descriptions provided herein are based on particular elastomers and levels of epoxidation, for example, about 25 mole % epoxidation, and that variations and other levels of epoxidation can be utilized. It should also be understood that reference to a natural rubber can include non-epoxidized natural rubber compounds, natural rubber compounds having some degree of epoxidized functional groups, or a combination thereof. In another aspect, blends of natural rubber and epoxidized natural rubber are described in this disclosure, and variations in the ratios between such elastomers can be made to account for lower or higher levels of epoxidation in the modified elastomer. One of skill in the art would be readily able, in view of the teachings of this disclosure, to make such changes and substitutions for a specific application.

In yet other aspects, the elastomer can comprise a blend and/or mixture of other elastomers, such as, for example, NR (e.g., NR-SMR CV60, available from Akrochem, Akron, Ohio, USA), butadiene rubber (BR), styrene butadiene rubber (SBR), ethylene propylene diene rubber (EPDM), nitrile rubber or acrylonitrile butadiene rubber (NBR), or a combination thereof. In still other aspects, the elastomer can optionally further comprise sulfur, accelerators, antioxidants, plasticizers, rheological aids, colorants, dispersants, coupling agents and/or other components typically utilized in elastomer compositions for use in, for example, tires.

In one aspect, the elastomer of the present invention can comprise a blend of natural rubber and an epoxidized natural rubber. In another aspect, the ratio of natural rubber to epoxidized natural rubber can vary, depending on the desired level of interaction, the carbon black used, and the desired properties of the resulting compound. In one aspect, the elastomer can comprise a blend having a ratio of natural rubber to epoxidized natural rubber (25 mole % epoxide) of about 90:10, about 80:20, about 70:30, about 60:40, about 50:50, about 40:60, about 30:70, about 20:80, or about 10:90. In another aspect, the elastomer can comprise a blend having a ratio of natural rubber to epoxidized natural rubber (25 mole % epoxide) of about 75:25, 50:50, or 25:75. In yet another aspect, the elastomer can comprise a blend having a ratio of natural rubber to epoxidized natural rubber (25 mole % epoxide) of from about 40:60 to about 60:40, from about 45:55 to about 55:45, or about 50:50. In another aspect, the elastomer can comprise a blend wherein each of the above recited ratios can also be recited as at least about, for example, 90:10, at least about 80:20, at least about 40:60, etc.

In one aspect, a compound comprising a blend of carbon blacks, for example, an non-oxidized carbon black, such as, for example, N234, and an oxidized carbon black, such as, for example, Carbon Black Example B, can be mixed with a blend of epoxidized natural rubber (ENR) and natural rubber (NR) for use in certain applications, such as truck/bus radial (TBR) tread and non-tread applications for passenger or truck tire compounds.

### Mixing and Dispersion

In one aspect, the components (i.e., functionalized elastomer and functionalized carbon black) can be contacted and/or mixed in a conventional order. In one aspect, the temperatures and mixing times can be similar to those in conventional mixing techniques, or can comprise shorter or longer times and/or higher or lower temperatures as required to achieve the correct dispersion level and balance of in-rubber properties. As used herein, the terms mix and mixing are intended to refer to contacting, and no particular amount of mixing and/or compounding is necessarily implied. One of skill in the art would readily understand if any level or degree of mixing and/or compounding were requisite for a described composition or evaluation.

In another aspect, blends of elastomers with ENR, such NR, SBR or BR can be used to improve the dispersion of the Carbon Black Example B or other functionalized carbon blacks and balance the compound performance for optimum properties as related to any given application. One of skill in the art would readily be able to determine appropriate ratios or blends for balancing properties, in view of the disclosure herein.

In another aspect, when two elastomers are used, for example, natural rubber and epoxidized natural rubber (e.g., 25 mole % epoxidation), the two elastomers can be contacted and optionally mixed prior to contact with other ingredients, so as to ensure homogenization of the elastomer blend.

In yet another aspect, an inventive elastomer composition can be prepared with several different carbon black surface treatment schemes with different chemistries, to synergistically interact with the functionalized polymer with functionalization along the polymer chain.

In various aspects, the inventive composition can comprise a functionalized polymer with functionalization along the polymer chain, and a surface treated carbon black, for example, treated by oxidation of the carbon black surface via peroxide (e.g. see U.S. Pat. No. 6,120,594) or ozone (e.g. see U.S. Pat. No. 6,471,933) to provide, for example, a polar-polar and/or intermolecular-hydrogen-bonding mechanism between the oxygen-based functional groups on the carbon black surface and the epoxide functionality along the polymer chain of the functionalized polymer. In another aspect, the functionalized carbon black can be surface treated by oxidation of the carbon black followed by treatment with amine-based compounds (e.g. see U.S. Pat. No. 5,708,055), such as, for example, diamine to tetramine or higher order amine compounds, that can provide an acid-base interaction between the basic amine functional groups on the carbon black and the epoxide groups along the polymer chain of the functionalized polymer.

A composition or mix can comprise one or more other materials conventionally used in processing rubber compounds, such as, for example, Vivatec 500 (mineral oil, available from Tudapetrol KG, Hamburg, Germany), calcium stearate (available from Sovereign Chemical Company, Akron, Ohio, USA), stearic acid (available from Western Reserve Chemical, Stow, Ohio, USA), zinc oxide (available from Aurora Rubber, Dickson, Tenn., USA), silica such as a precipitated silica (available from Solvay Silica, Cranbury, N.J., USA), TESPT coupling agent (available from Alfa Aesar, Tewksbury, Mass., USA), TP 130C (available from Bhavik Enterprise, Maharashtra, India), 6PPD (N-(1,3-Dimethylbutyl)-N′-phenyl-p-phenylenediamine, available from Eastman Chemical Company, Kingsport, Tenn., USA), TMQ (2,2,4-Trimethyl-1,2-Dihydroquinoline, available from Sovereign Chemical Company, Akron, Ohio, USA), Sulfur (commercially available), TBBS (N-tert-butyl-benzothiazole sulfonamide, available from Western Reserve Chemical, Stow, Ohio, USA), CBS (N-cyclohexyl-2-benzothiazole sulfenamide, available from Western Reserve Chemical, Stow, Ohio, USA), and DPG (diphenyl guanidine, available from Akrochem, Akron, Ohio, USA).

In one exemplary aspect, mixing can be performed in a 1.5 liter (internal chamber volume) BR-1600 Banbury, Model Tecnolab from Farrel Corporation. In a typical aspect, a three-stage mix can be employed, with the first two passes designed for incorporation and dispersion of filler and rubber chemicals that typically comprise a tire tread compound, followed by a productive pass for incorporation of curatives. Tread rubber compounds can be mixed in a conventional manner at temperatures in the range of 60° C. to 150° C., for 3 to 5 minutes per pass, followed by the productive stage at a lower temperature and shorter mixing time. Silica-based TBR tread compounds can be mixed in a reactive mixing manner that requires higher temperature in the range of 130° C. to 160° C. for 3 to 8 minutes per pass, and done in such a manner so that a coupling agent, such as TESPT, can undergo coupling reactions. For compounds of the present disclosure, epoxidized NR can be sensitive to acids and the low pH of the surface-modified carbon blacks can result in chain scission and a reduction in mix viscosity and shear, thus it has been recommended by the manufacturer to add calcium stearate to minimize the impact of the acids on the ENR polymer.

Exemplary formulations are detailed in Table 2, below. It should be noted that formulations can vary based on the ingredients and the desired properties of the resulting compound, and one of skill in the art, in view of this disclosure, could readily determine an appropriate formulation for a given application.

TABLE 2
Exemplary Formulations Comparing NR/N234 to ENR/Carbon
Black Example B to NR/Carbon Black Example B and
Blends of NR/ENR with Carbon Black Example B

| | Mix Identification | | | | | |
|---|---|---|---|---|---|---|
| Ingredient, phr | Control E | Exp. F | Exp. G | Exp. H | Exp. I | Exp. J |
| NR-SMR CV60 | 100 | 0 | 25 | 50 | 75 | 100 |
| ENR-25 | 0 | 100 | 75 | 50 | 25 | 0 |
| N234 | 55 | 0 | 0 | 0 | 0 | 0 |
| Carbon Black Example B | 0 | 55 | 55 | 55 | 55 | 55 |
| TDAE Oil | 5 | 5 | 5 | 5 | 5 | 5 |
| Calcium Stearate | 1 | 1 | 1 | 1 | 1 | 1 |
| Zinc Oxide | 3 | 3 | 3 | 3 | 3 | 3 |
| Stearic Acid | 3 | 3 | 3 | 3 | 3 | 3 |
| 6PPD | 1 | 1 | 1 | 1 | 1 | 1 |
| TMQ | 1 | 1 | 1 | 1 | 1 | 1 |
| Sulfur | 1.8 | 1.8 | 1.8 | 1.8 | 1.8 | 1.8 |
| TBBS | 2.4 | 2.4 | 2.4 | 2.4 | 2.4 | 2.4 |
| DPG | 0 | 1.5 | 1.5 | 1.5 | 1.5 | 1.5 |
| Total, phr | 173.2 | 174.7 | 174.7 | 174.7 | 174.7 | 174.7 |

In one aspect, a compound comprising an epoxidized natural rubber elastomer can be subjected to a remilling step to improve dispersion and decrease viscosity of the resulting compound. In the example protocols detailed below, the procedure of milling the compound for one minute and then rolling or banding and removing it from the mill, and cross blending again (called piging) was repeated 10-20 times for each sample for improving dispersion and comparative purposes only. Typically a dispersion >80 or 85 (0 to 100 scale with 100 being a perfect dispersion) might not require remilling in actual practice. Exemplary mixing and milling protocols are detailed in Table 3, below.

TABLE 3
Mixing and Milling Protocols

| | | |
|---|---|---|
| Time | | |
| (sec) | RPM | Process |

NR/ENR Masterbatch Pre-blending

| | | |
|---|---|---|
| — | 77 | Load: Polymer |
| 240 | 77 | Ram Down Mixing |
| ~240 | — | Discharge |

Mill: 70° C., 25:21 rpm, Gap 0.055-60″
Pass through mill once, band and cross-blend 6x Pig 4x
Band 30 seconds, sheet-off, and let cool for minimum of 1 hour
First Pass: 40° C., 70 rpm, 3.0 bar

| | | |
|---|---|---|
| 30 | 70 | Load: Polymer + Calcium Stearate |
| 30 | 70 | Load: Chemicals: ZnO, Stearic Acid, Calcium Stearate, |
| | | TMQ, Micro Wax, 6PPD, ½ of Carbon Black |
| — | 70 | Load: ½ of Carbon Black + Oil (blended) |
| 180 | Varies | Ram Down Mixing (150° C. Max - Slow RPM if |
| | | necessary) |
| ~300 | — | Discharge |

Mill: 70° C., 25:21 rpm, Gap 0.055-60″
Pass through mill once, band and cross-blend 6x Pig 4x
Band 30 seconds, sheet off, and let cool for minimum of 1 hour
Productive Pass: 25° C., 60 rpm, 3.0 bar

| | | |
|---|---|---|
| 30 | 60 | Load: ½ MB, Chemicals, ½ MB |
| 150 | 45 | Ram Down Mixing (100° C. max - adjust RPM as |
| | | needed) |
| ~190 | — | Discharge |

Mill: 70° C., 25:21 rpm, Gap 0.055-60″
Pass through mill once, band and cross-blend 6x Pig 4x
Band 30 seconds, sheet off, and let cool for at least 1 hour

### Applications

In various aspects, the inventive compositions can be used in, for example, passenger tires, truck tires, and/or other mechanical rubber goods as a way to lower hysteresis and/or heat buildup in such compounds.

### Properties & Results

It should be understood that any examples or references to, for example, Carbon Black Example B, can also be intended to refer to any functionalized carbon black material suitable for use with the present invention.

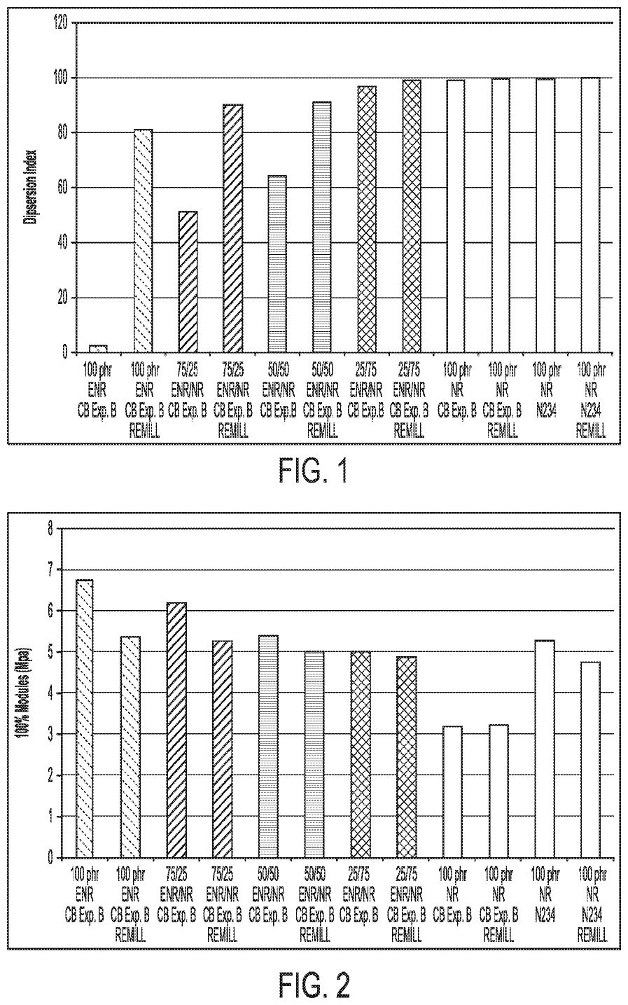

As illustrated below in FIG. 1, the use of Carbon Black Example B resulted in poor dispersion when mixed with ENR, such as, for example, EKOPRENA™ alone, presumably due to a fast and high degree of filler-elastomer interaction; nonetheless, with additional remilling the Carbon Black Example B can achieve a reasonable dispersion level, but this represents an unfavorable situation with regard to mixing in a factory setting. Note also that the Carbon Black Example B disperses very well in natural rubber, which is essentially non-functionalized, confirming that the functionalization and fast reaction may be impeding the Carbon Black Example B dispersion in ENR. Thus, a significant aspect of this invention is also a method for mixing ENR with a functionalized carbon black for improved dispersion and compounding flexibility.

NR and Carbon Black Example B were found to disperse very well together. As a result of this unexpected dispersion, blends of ENR and NR to facilitate the dispersion of Carbon Black Example B were considered. As seen in FIG. 1, when ENR was first blended with NR in 75/25, 50/50, and 25/75 ratios, and then mixed with Carbon Black Example B, the fast reactivity was reduced and the resulting compound exhibited significantly improved dispersion, and as is shown later, still provides significant benefits in reducing hysteresis. Compounds of Carbon Black Example B with a 50:50 and 75:25 blend of NR/ENR showed the best improvement of dispersion, and as will be shown, the 50:50 NR/ENR blend with Carbon Black Example B gave the best overall balance of dispersion and viscoelastic properties.

Table 4 shows a summary of the resulting in-rubber properties for the elastomer blends when mixed with either N234 or Carbon Black Example B. As can be seen, Shore A hardness is relatively unimpacted by the dispersion level, while the Mooney viscosity shows a resulting decrease in change upon remilling as the dispersion improves and more NR is added in the elastomer blend, leveling off in the range of 50 to 55 MU for all compounds.

TABLE 4
In-Rubber data for ENR/NR Blends and NR and ENR Controls with N234 and Carbon Black Example B showing
changes in Hardness, Mooney Viscosity, Modulus, Tensile Strength, Elongation and Dynamic Properties

| | | | 100 phr | | 75/25 | | 50/50 |
|---|---|---|---|---|---|---|---|
| | | 100 phr | ENR | 75/25 | ENR/NR | 50/50 | ENR/NR |
| | | ENR | CB Exp. B | ENR/NR | CB Exp. B | ENR/NR | CB Exp. B |
| Test | Unit | CB Exp. B | REMILL | CB Exp. B | REMILL | CB Exp. B | REMILL |
| IFM Dispersion | — | 2.3 | 80.7 | 51.3 | 90.0 | 63.8 | 91.0 |
| Hardness | Shore A | 74.1 | 71.5 | 72.1 | 70.1 | 72.1 | 72.1 |
| Mooney Viscosity, ML(1 + 4) @ 100° C. | MU | 99.1 | 66.9 | 82.5 | 55.8 | 71.4 | 54.4 |
| 100% Modulus | MPa | 6.7 | 5.4 | 6.2 | 5.3 | 5.4 | 5.0 |
| 200% Modulus | MPa | 15.0 | 13.5 | 14.4 | 13.2 | 12.5 | 12.0 |
| 300% Modulus | MPa | — | 22.0 | 22.4 | 21.4 | 19.9 | 19.1 |
| Tensile Strergth | MPa | 17.9 | 24.7 | 22.4 | 25.1 | 22.9 | 26.4 |
| Elongation | % | 239 | 332 | 301 | 357 | 352 | 421 |
| Tan Delta in Shear @ 60° C. | — | 0.138 | 0.162 | 0.134 | 0.170 | 0.167 | 0.183 |
| Delta G′ in Shear (0.8-80) @ 60° C. | MPa | 3.38 | 3.75 | 3.05 | 4.11 | 4.52 | 4.80 |

| | | | 25/75 | | 100 phr | | 100 phr |
|---|---|---|---|---|---|---|---|
| | | 25/75 | ENR/NR | 100 phr | NR | 100 phr | NR |
| | | ENR/NR | CB Exp. B | NR | CB Exp. B | NR | N234 |
| Test | Unit | CB Exp. B | REMILL | CB Exp. B | REMILL | N234 | REMILL |
| IFM Dispersion | — | 96.6 | 99.2 | 98.9 | 99.6 | 99.5 | 99.8 |
| Hardness | Shore A | 72.7 | 73.5 | 69.9 | 68.7 | 71.9 | 71.5 |
| Mooney Viscosity, ML(1 + 4) @ 100° C. | MU | 60.3 | 50.6 | 58.3 | 53.2 | 71.0 | 55.3 |
| 100% Modulus | MPa | 5.0 | 4.9 | 3.2 | 3.2 | 5.3 | 4.7 |
| 200% Modulus | MPa | 11.5 | 11.3 | 7.3 | 7.6 | 13.6 | 12.5 |
| 300% Modulus | MPa | 18.5 | 18.0 | 12.9 | 13.3 | 21.2 | 20.3 |
| Tensile Strergth | MPa | 25.3 | 26.0 | 25.9 | 26.6 | 28.8 | 28.3 |
| Elongation | % | 414 | 443 | 524 | 550 | 427 | 435 |
| Tan Delta in Shear @ 60° C. | — | 0.226 | 0.229 | 0.230 | 0.235 | 0.231 | 0.240 |
| Delta G′ in Shear (0.8-80) @ 60° C. | MPa | 7.67 | 7.59 | 9.29 | 8.89 | 8.38 | 9.70 |

FIG. 2 illustrates a change in modulus for Carbon Black Example B and N234 in NR and ENR compounds and blends. As illustrated in FIG. 2, the 100% Modulus values were higher for compounds with Carbon Black Example B with higher ENR content, but settle to a nearly constant value of about 5 MPa after remilling. The sample comprising Carbon Black Example B in 100 phr NR exhibited a significant drop in modulus and had the lowest 100% modulus value, whereas the sample comprising N234 in 100 phr NR exhibited similar 100% modulus to other ENR/NR blends. The drop in modulus for the NR/Carbon Black Example B compound appears to indicate reduced Carbon Black Example B/NR interaction due to the polarity differences between the two materials, while the increase in modulus when using ENR in blends with NR, indicates a strong interaction between the Carbon Black Example B and the functionalized ENR. Thus, in various aspects, the compositions of the present disclosure can have a 100% Modulus of at least about 4.5 MPa, at least about 5 MPa, at least about 5.5 MPa, or at least about 6 MPa.

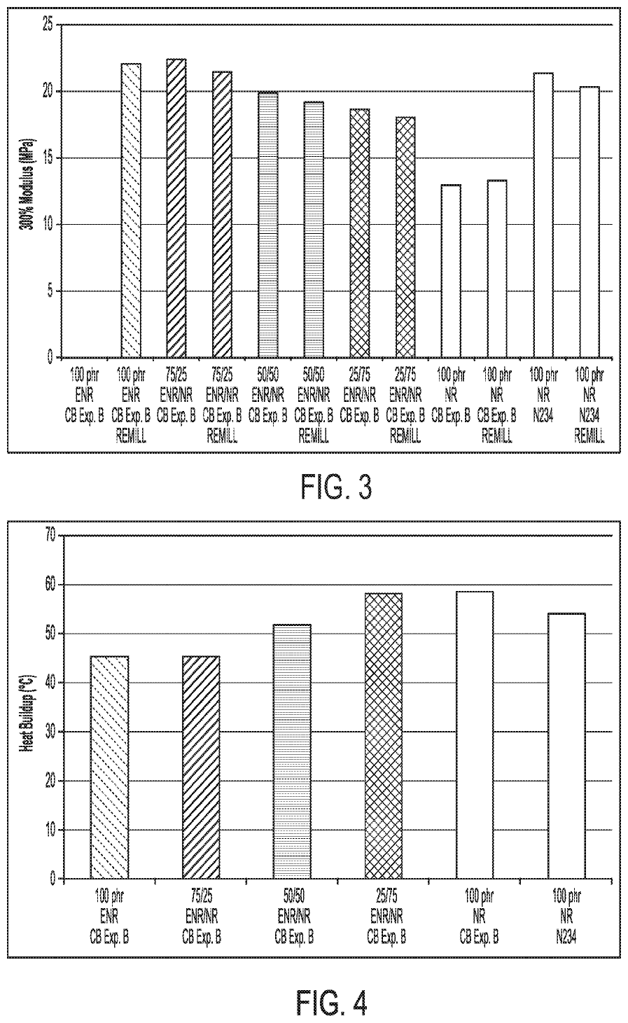

Similarly, the 300% modulus values were higher for samples containing Carbon Black Example B with higher ENR content and decreased slightly after remitting, as illustrated in FIG. 3, below. Note that blends of ENR/NR with Carbon Black Example B achieve modulus levels similar to N234 in NR, indicating a good balance of reinforcement and good stiffness. Similarly, in various aspects, the compositions of the present disclosure can have a 300% Modulus of at least about 15 MPa, at least about 16 MPa, at least about 17 MPa, at least about 18 MPa, at least about 19 MPa, or at least about 20 MPa.

Elongation results were lower for compounds having higher ENR content and poorer dispersion, but increased for remitted compounds. The sample comprising Carbon Black Example B with 100 phr NR exhibited the highest elongation and lowest modulus, and the sample comprising N234 in 100 phr NR was comparable to the 50/50 ENR/NR blend. In general, modulus build increases for compounds comprising Carbon Black Example B and a higher proportion of ENR.

In terms of hysteretic properties, the rebound for all compounds containing ENR are lower than the NR-based compounds, primarily due to the epoxidation and increased dampening and Tg of the ENR versus NR. Nonetheless, Tables 4 and 5 show the tangent delta values at 60° C. for the ENR-based compounds with Carbon Black Example B, and reveal significant advantages in reducing the tan delta and predicted rolling resistance of the ENR-based compounds. The tangent delta reduction verus N234 in all NR, ranges from 24% to 29% to 32% for the ENR/NR-Carbon-Black-Example-B blends ranging from 50:50 to 75:25 to 100:0, respectively.

TABLE 5
In-Rubber data for ENR/NR Blends and NR and ENR
Controls with N234 and Carbon Black Example B,
showing changes in tan delta with varied ENR/NR
ratios and the oxidized Carbon Black Example B.

| | | Normalized |
|---|---|---|
| Compound | Tan delta @ 60° C. | Value |
| Control E: N234 in 100 phr NR | 0.240 | 100 |
| Exp. F: CB Example B in 100 phr | 0.162 | 67.5 (32.5% |
| Ekoprena | | decrease) |
| Exp. G: CB Example B 75/25 | 0.170 | 70.8 (29.2% |
| Ekoprena/NR | | decrease) |
| Exp. H: CB Example B 50/50 | 0.183 | 76.2 (23.8% |
| Ekoprena/NR | | decrease) |
| Exp. I: CB Example B 25/75 | 0.229 | 98.9 (1.1% |
| Ekoprena/NR | | decrease) |
| Exp. J: CB Example B 100 phr NR | 0.235 | 99.5 (0.5% |
| | | decrease) |

Heat buildup results are shown in FIG. 4 and were performed on a subset of the samples obtained by the protocols in Table 3. Heat buildup was performed using a Goodrich Flexometer. The results reveal the heat buildup reduces dramatically relative to the N234 in all NR for the Carbon Black Example B in ENR/NR and decreases with increasing ENR content. In one aspect, the compositions of the present disclosure can have a heat buildup of less than about 55° C., less than about 54° C., less than about 53° C., less than about 52° C., less than about 51° C., less than about 50° C., less than about 49° C., less than about 48° C., less than about 47° C., less than about 46° C., or less than about 45° C.

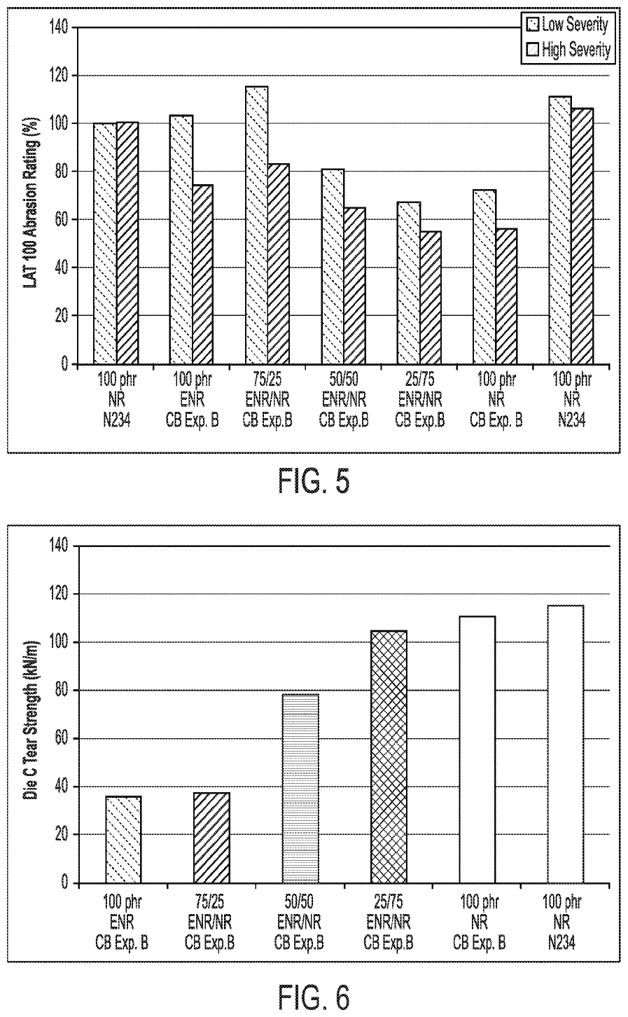

Abrasion testing was also performed on the same subset of the samples obtained by the protocols in Table 3 using a LAT 100 compound tester and the results are shown in FIG. 5. Tests were performed at slip angles of 16°, 12°, and 5.5°; at speeds of 25 km/hr, 8 km/hr, and 2.5 km/hr; at a load of 75 N; and using a Corundum 60 test surface. The test measured abrasion loss (mg/km), abradability (mg/kJ), slide force coefficient, and surface temperature (° C.), and the abrasion rating was determined as a function of input energy (W) and speed (v). The control compound, N234 in all NR was set to a value of 100, and all other compounds were rated relative to this compound. The control was analyzed twice, one at the start of the analysis and once at the end. In one aspect, the compositions disclosed herein can have a LAT 100 Abrasion Rating of from about 80% to about 120%, from about 85% to about 115%, or from about 90% to about 110%, of that of N234 in NR control sample.

Abrasion resistance (higher is better) was lowest for the all NR or 25/75 ENR/NR compounds with Carbon Black Example B, and is in line with the decreased modulus and level of interaction of Carbon Black Example B in NR. As the ENR content is increased in compounds with Carbon Black Example B, the abrasion resistance also increases, with all ENR compounds showing higher, low severity abrasion resistance than the N234, all NR control, while the high severity abrasion resistance shows diminished abrasion resistance relative to the N234, all NR control.

Tear Strength, Die C, was also performed on the same subset of the samples in Table 2 and the results are shown in FIG. 6. The results show that all NR compounds that contain either Carbon Black Example B or N234 have similar and high Die C tear strength, However when ENR is added to the NR (in compounds containing only the Carbon Black Example B), the tear strength shows a decline as more ENR is added. Thus compounds with a 75/25 or 50/50 blend of ENR/NR appear best suited for industrialization such as to maintain a higher level of tear strength. Thus, in various aspects, the compositions of the present disclosure can have a Die C Tear Strength of at least about 35, at least about 40, at least about 50, at least about 60, at least about 70, at least about 75, at least about 80, at least about 90, or at least about 100 kN/m, or more.

The impact on dispersion and final viscoelastic properties such as modulus, abrasion resistance, tangent delta and tear, when using a combination of Carbon Black Example B with ENR and NR (or other elastomers), is a factor that has to be considered when choosing the best elastomer blend ratio. In the end, the blends of ENR and NR in the range of 50/50 up to 75/25 appear to be a very reasonable compromise that provides the best balance of properties. However, further detailed examination of the elastomer blend composition and carbon black phase distribution at the nano and micro-scale are required for final optimization and understanding.

It should understood that the compositions of the present disclosure can have any combination of properties recited herein, for example, a 100% Modulus of at least about 5 MPa and a heat buildup of less than about 50° C. Other combinations of two, three, or more properties are contemplated and are intended to be covered by this disclosure.

Carbon Black Phase Distribution

Whenever elastomers of different polarity are mixed, for example NR and ENR, the phase location of the carbon black between the respective elastomers can be significant for the performance properties of the resulting composition. Ideally, the carbon black is distributed uniformly between the phases for maximum reinforcement. Similarly, the crosslink density is uniform between the phases. One method of evaluating carbon black phase distribution is to utilize atomic force microscopy (AFM), that when operated in tapping mode can distinguish inherent differences in the interaction of the tip with the surface. Such interactions can be attributed to the different moduli of the blended elastomer phase domains.

When Carbon Black Examples A, B and/or C, which are oxidized carbon blacks as described in Table 1, are mixed with a blend of epoxidized natural rubber (ENR), such as for example, EKOPRENA™, and natural rubber (NR), the carbon black can preferentially locate in the ENR phase due to its polarity. Such a distribution can impact rubber properties.

When a 75/25 pure-gum blend (void of carbon black or silica) of NR/ENR is viewed by AFM, phase contrast between the two elastomers is easy to observe due to differences in their stiffness at the experimental temperature resulting from differences in their glass transition temperatures. When an N234 carbon black is mixed in 100 phr NR, AFM reveals the expected network of carbon black, well dispersed in the NR elastomer. Similarly, when Carbon Black Examples A, B or C are mixed in 100 phr NR, the well-dispersed carbon black network is readily visible showing the distribution in the NR elastomer.

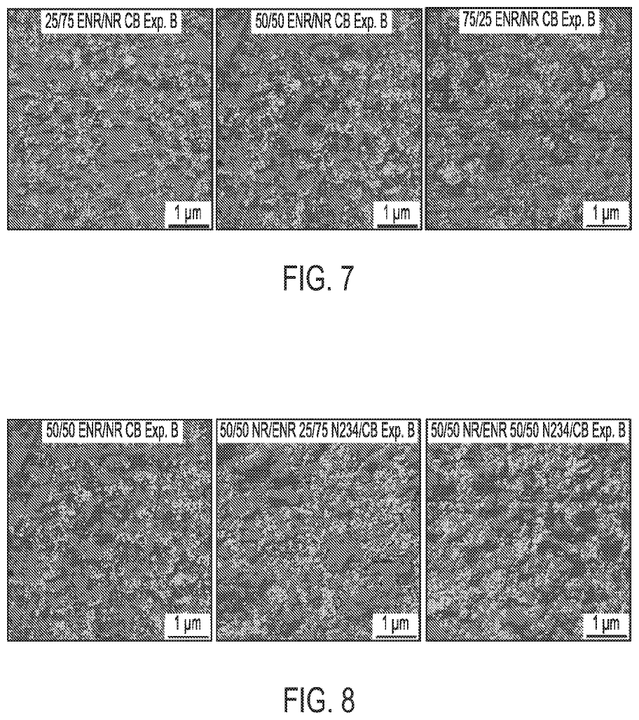

When the same Carbon Black Example B is mixed in a 75/25 blend of NR/ENR, the oxidized carbon black appears to be mostly present only in the ENR domains of the compound, while the NR phase appears virtually unpigmented. When the same carbon black is mixed in either a 50/50 blend or a 25/75 blend of NR/ENR, the carbon black still remains substantially in the ENR phase. This preference of Carbon Black Example B for the functionalized ENR phase is clearly shown in atomic force microscopy images in FIG. 7 below (Carbon Black Example B=white, NR=gray, ENR=black).

Location of the carbon black in only one phase is again generally an undesirable feature for most rubber compounds and it reduces the available volume for the carbon black network, jamming it, resulting in potentially a higher degree of networking and heat buildup. Additionally, having one elastomer phase totally unpigmented could result in poor physical properties for that compound including reduced stiffness (modulus), treadwear and tear strength. Thus it is generally desirable to have both phases evenly pigmented.

It can be assumed that a blend of a regular ASTM grade with Carbon Black Example B in the same ratio as the NR/ENR, would provide an equal distribution of carbon black between the two phases, with the ASTM, non-functionalized grade preferring the NR phase and the Carbon Black Example B preferring the ENR phase. In fact, utilization of such a strategy may allow a significant benefit in controlling the carbon black phase distribution and optimizing the final viscoelastic compound properties, including the compound resistivity.

The following compounds shown in Table 6 were mixed to evaluate blends of carbon blacks and elastomers to further validate the hypothesis that the use of a controlled phase distribution can be used optimize the viscoelastic properties of the various rubber compounds.

TABLE 6
Carbon Black Example B with blends of N234 in 50/50 NR/ENR blends for controlling
carbon black phase distribution and viscoelastic properties.

| | | | | Exp. W | Exp. X | |
|---|---|---|---|---|---|---|
| | Control T | Exp. U | Exp. V | 50/50 | 50/50 | Exp. Z |
| | 100 phr | 50/50 | 50/50 | NR/ENR | NR/ENR | 50/50 |
| Ingredients, | NR | NR/ENR | NR/ENR | 25/75 | 50/50 | NR/ENR |
| phr | N234 | N234 | CB Exp. B | N234/CB Exp. B | N234/CB Exp. B | Silica |
| NR | 100 | 50 | 50 | 50 | 50 | 50 |
| ENR | — | 50 | 50 | 50 | 50 | 50 |
| N234 | 55 | 55 | — | 13.75 | 27.5 | — |
| N330 | — | — | — | — | — | 3 |
| CARBON | — | — | 55 | 41.25 | 27.5 | — |
| BLACK | | | | | | |
| EXAMPLE B | | | | | | |
| Silica | — | — | — | — | — | 55 |
| Silane, TESPT | — | — | — | — | — | 5 |
| TDAE Oil | 5 | 5 | 5 | 5 | 5 | 8 |
| Ca Stearate | 1 | 1 | 1 | 1 | 1 | — |
| ZnO | 3 | 3 | 3 | 3 | 3 | 2.5 |
| Stearic Acid | 3 | 3 | 3 | 3 | 3 | 1 |
| 6PPD | 1 | 1 | 1 | 1 | 1 | — |
| TMQ | 1 | 1 | 1 | 1 | 1 | 2 |
| Sulfur | 1.8 | 1.8 | 1.8 | 1.8 | 1.8 | 1.4 |
| TBBS | 2.4 | 2.4 | 2.4 | 2.4 | 2.4 | — |
| CBS | — | — | — | — | — | 1.7 |
| DPG | — | — | 1.5 | 1.5 | 1.5 | 2 |
| Total phr | 173.2 | 173.2 | 174.7 | 174.7 | 174.7 | 181.6 |

As seen in Table 6, two reference compounds, N234 in 100 phr of NR and in a 50/50 NR/ENR blend were mixed and compared to Carbon Black Example B in a 50/50 blend of NR/ENR but with varied ratios of N234 and Carbon Black Example B, namely, 0/100, 25/75, and 50/50 N234/Carbon Black Example B.

FIG. 8 depicts AFM images of the compounds in the same order and it is clear that as more N234 is added to the compound, the NR phase becomes more populated with carbon black that is assumed to be N234. This is especially noticeable in the 50/50 N234/Carbon Black Example B blend (Carbon Black Example B=white, NR=gray, ENR=black).

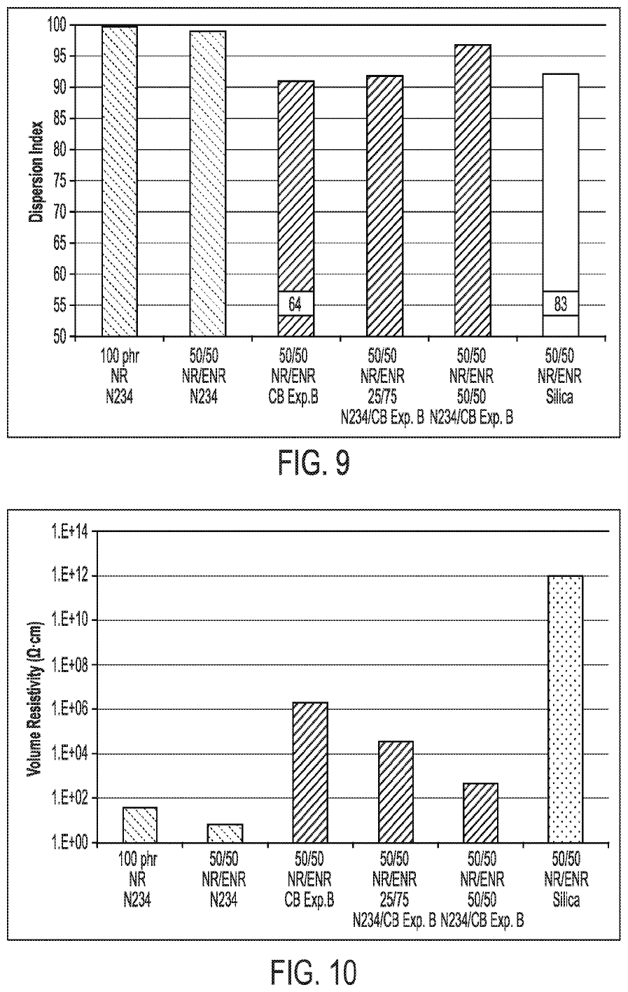

FIG. 9 shows the dispersion achieved via blending of Carbon Black Example B with an ASTM grade. It is clear that when partially substituting the Carbon Black Example B with an ASTM grade such as N234, that a very good dispersion (>90) is achieved (see Compound: 50/50 NR/ENR with 25/75 and 50/50 N234/Carbon Black Example B). These dispersion levels represent a significant increase versus all Carbon Black Example B in 50/50 NR/ENR with an increase from a non-milled dispersion index of 64 up to >90. Note that the all Carbon Black Example B and Silica, both in a 50/50 NR/ENR blend, show poor dispersions as noted in the box on their respective histogram bars, and required re-milling, as discussed previously, to achieve dispersions >80. The Carbon Black Example B and N234 blends did not require any additional re-milling to achieve their respective dispersions that are both >90. Thus, in various aspects, an elastomer composition comprising an at least partially epoxidized elastomer, such as, for example, natural rubber, and a functionalized carbon black, such as, for example, CD2125XZ or Carbon Black Example B, can yield a dispersion index (DI) value of at least about 80, at least about 82, at least about 84, at least about 85, at least about 86, at least about 88, at least about 90, at least about 92, at least about 94, at least about 96, at least about 98, at least about 99, or about 100.

A second advantage of this filler blending method is seen in the compound resistivity. The all Carbon Black Example B in the 50/50 NR/ENR elastomer blend yields a conductivity that is just in the dissipative range, but when a 50/50 blend of N234 and Carbon Black Example B is used, the conductivity drops below the dissipative range and into a solidly conductive range, which is required for tires to prevent charge buildup. Note that silica has the highest resistivity compared to any of the carbon black compounds, non-functionalized or functionalized and represents a significant disadvantage for this compound technology. FIG. 10 illustrates compound resistivity as a function of filler type and blend ration, and elastomer blend ratio.

TABLE 7
In-rubber properties for the compounds described in Table 6.

| | | | | | 50/50 | 50/50 | |
|---|---|---|---|---|---|---|---|
| | | 100 phr | 50/50 | 50/50 | NR/ENR | NR/ENR | 50/50 |
| | | NR | NR/ENR | NR/ENR | 25/75 | 50/50 | NR/ENR |
| Test | Unit | N234 | N234 | CB Exp. B | N234/CB Exp. B | N234/CB Exp. B | Silica |
| IFM Dispersion | — | 99.8 | 99.6 | 91.0 | 91.8 | 96.8 | 92.1 |
| Hardness | Shore A | 71.5 | 74.7 | 72.1 | 72.1 | 72.5 | 71.7 |
| Mooney Viscosity, ML(1 + 4) @ 100° C. | MU | 55.3 | 61.6 | 54.4 | 55.8 | 58.5 | 56.4 |
| 100% Modulus | MPa | 4.7 | 6.2 | 5.0 | 5.4 | 5.7 | 4.1 |
| 200% Modulus | MPa | 12.5 | 14.6 | 12.0 | 13.1 | 13.5 | 9.7 |
| 300% Modulus | MPa | 20.3 | 21.6 | 19.1 | 20.0 | 20.5 | 15.8 |
| Tensile Strength | MPa | 28.3 | 27.5 | 26.4 | 25.0 | 26.1 | 24.2 |
| Elongation | % | 435 | 407 | 421 | 374 | 391 | 447 |
| Rebound @ 25° C. | % | 46.9 | 32.2 | 33.4 | 32.3 | 31.2 | 33.6 |
| Tan Delta in Shear @ 60° C. | — | 0.240 | 0.238 | 0.183 | 0.184 | 0.200 | 0.165 |
| Delta G′ in Shear (0.8-80) @ 60° C. | MPa | 9.70 | 7.36 | 4.80 | 4.49 | 4.87 | 5.51 |

The hardness levels of the compounds in Table 7 are very similar in the range of 72 to 75, while the Mooney viscosity is also similar with values in the range of 55 to 57.

Modulus shows a slight increase with Carbon Black Example B as the N234 content increases in the blend, most likely as a result of more N234 in the NR phase as opposed to Carbon Black Example B. However, both N234/Carbon Black Example B blends have a similar modulus, tensile and elongation compared to the all N234 in NR. The compound with all N234 in the 50/50 NR/ENR blend has the highest Modulus, while silica has the lowest modulus by a significant amount.

In terms of hysteresis, the rebound for the 50/50 NR/ENR compounds shows that as the Carbon Black Example B content is lowered, the rebound decreases, but only slightly. However, this property seems more impacted by the ENR itself than by the changes in filler type and ratio.

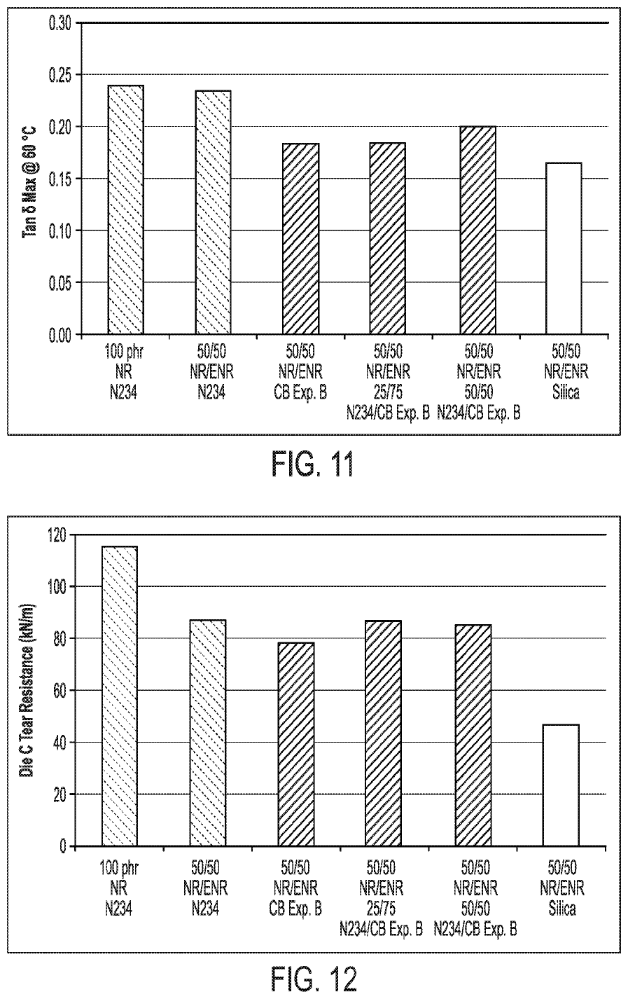

On the other hand, the tangent delta values for these compounds at 60° C., show a relatively large decrease for the all Carbon Black Example B in 50/50 NR/ENR, with a corresponding slight increase in tangent delta with increasing N234 in the filler blend, behaving in a rather classical manner. These results are also shown in FIG. 11, below.

In terms of tear strength, as shown before, ENR itself is a weaker elastomer than NR and thus the 50/50 NR/ENR blend with N234 shows a relatively large drop in Die C tear strength compared to all N234 in an all NR compound (FIG. 12). The use of Carbon Black Example B with N234 shows a slight drop in tear strength versus N234 in the same 50/50 NR/ENR blend, but one may consider it essentially equal with no significant impact from using a different filler combination in the 50/50 NR/ENR blend. Silica is shown to have significantly worse tear strength than any of the carbon black based compounds with NR or NR/ENR elastomer blends.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An elastomer composition comprising a functionalized carbon black and an at least partially epoxidized elastomer.

2. The elastomer composition of claim 1, wherein the at least partially epoxidized elastomer comprises an epoxidized natural rubber.

3. The elastomer composition of claim 1, wherein the functionalized carbon black comprises an oxidized carbon black, an amine treated carbon black, or a combination thereof.

4. (canceled)

5. The elastomer composition of claim 1, wherein the functionalized carbon black comprises a carbon black having one or more of: a void volume of about 55.6, an electron microscopy surface area of about 123 m²/g,

6. The elastomer composition of claim 1, wherein the functionalized carbon black comprises a CD2125XZ grade carbon black.

7. (canceled)

8. The elastomer composition of claim 1, having a dispersion index of at least about 80.

9. (canceled)

10. (canceled)

11. The elastomer composition of claim 1, having at least one of a 100% Modulus of at least about 5 MPa, a 300% Modulus of at least about 15 MPa, or a heat buildup of less than about 50° C.

12. (canceled)

13. (canceled)

14. The elastomer composition of claim 1, wherein the elastomer composition comprises a blend of natural rubber and epoxidized natural rubber.

15. The elastomer composition of claim 14, wherein the ratio of natural rubber to epoxidized natural rubber is from about 20:80 to about 80:20.

16. (canceled)

17. (canceled)

18. (canceled)

19. The elastomer composition of claim 1, further comprising an unmodified carbon black.

20. The elastomer composition of claim 19, wherein the unmodified carbon black is substantially similar, except in surface functionality, to the functionalized carbon black.

21. The elastomer composition of claim 19, wherein the unmodified carbon black comprises a tread grade carbon black and wherein the functionalized carbon black comprises a functionalized tread grade carbon black.

22. The elastomer composition of claim 19, wherein the unmodified carbon black comprises an N234 grade carbon black and the functionalized carbon black comprises CD2125XZ grade carbon black.

23. The elastomer composition of claim 1, comprising natural rubber, an epoxidized natural rubber, an unmodified carbon black, and a functionalized carbon black.

24. The elastomer composition of claim 23, wherein the ration ratio of natural rubber to epoxidized natural rubber is substantially similar to the ratio of unmodified carbon black to functionalized carbon black.

25. The elastomer of claim 23, wherein carbon black, including both the unmodified carbon black and the functionalized black is substantially uniformly distributed in the elastomer blend.

26. A method for preparing an elastomer composition, the method comprising contacting a functionalized carbon black and an at least partially epoxidized elastomer.

27. The method of claim 26, wherein the at least partially epoxidized elastomer comprises an at least partially epoxidized natural rubber.

28. (canceled)

29. The method of claim 26, wherein the functionalized carbon black comprises an oxidized carbon black, an amine treated carbon black, or a combination thereof.

30. (canceled)

31. (canceled)

32. (canceled)

33. A method comprising contacting a surface modified carbon black, and an unmodified carbon black, with epoxidized natural rubber.

34. (canceled)
